(19) United States
(12) Patent Application Publication
(10) Pub. No.: US 2018/0235385 A1
(43) Pub. Date: Aug. 23, 2018

(54) HOLDING DEVICE FOR ADHESIVE FASTENING TO A SURFACE, HAVING AN ALLOCATED FASTENING ELEMENT

(71) Applicant: TESA SE, Norderstedt (DE)

(72) Inventors: Franz FASTERMANN, Elmshorn (DE); Martje MASSON, Hamburg (DE); Robert WEIGL, Hamburg (DE)

(73) Assignee: TESA SE, Norderstedt (DE)

(21) Appl. No.: 15/754,148

(22) PCT Filed: Aug. 10, 2016
(86) PCT No.: PCT/EP2016/069011

§ 371 Date: Feb. 21, 2018

(30) Foreign Application Priority Data
Aug. 21, 2015 (DE) 10 2015 215 992.2

(51) Int. Cl. A47G 1/17; F16B 33/02; F16B 37/04

(52) U.S. Cl. CPC A47G 1/175; F16B 33/006; F16B 37/048; F16B 33/02

(57) ABSTRACT

The invention relates to a holding device for adhesive fastening to a surface, comprising a holding element and an allocated fastening element, wherein the holding element has a base plate having a rear surface and a threaded bolt protruding over the base plate, wherein the fastening element can be attached to the threaded bolt of the holding element, wherein the fastening element has a continual opening and is elastic at least in the region of the opening, and wherein the opening has an inner diameter which, in relation to an outer diameter of the threaded bolt, is designed such that the fastening element can be both placed on and removed from and, by a rotating motion, screwed onto or off of the threaded bolt.

The present invention relates to a holding device for adhesive fastening to a surface having a holding body and an associated fastening element, wherein the holding body has a base plate with a rear surface and a threaded bolt protruding above the base plate, wherein the fastening element can be attached to the threaded bolt of the holding body.

Adhesively fastenable holding bodies, such as for example self-adhesive hooks, are known from the prior art and are used, for example, in order to hang objects such as kitchen utensils or hand towels on walls. However, not all objects can be hung on a simple hook-like projection. For objects or wall-mounted racks such as key boards or spice racks which are not often taken down and which have flat elements with holes or slots in the vicinity of their edge, screw connections are more suited for wall mounting. It is thus customary to provide an internal thread in the form of an anchor countersunk in the load-bearing wall. A screw which passes through the hole in the object can be screwed into the anchor in order to fix the object. It is, however, a disadvantage of such a solution that holes need to be drilled in the wall. This can result in a significantly impaired visual appearance in particular in the case of tiled surfaces or recently treated walls.

In these cases, holding devices present themselves which can be attached to a surface using double-sided self-adhesive strips and provide a screw connection. A holding device is known from EP 1 945 073 B1 which can be fastened to a wall by a double-sided adhesive strip. The holding device has a base plate with a flat rear surface and a front surface which can be connected to a sleeve bearing a thread. Holding elements are arranged around the sleeve. A profile can be firmly clamped, by means of the threaded screw, between the holding elements and the head of a threaded screw.

KR 2011 0 101 490 A discloses a holding device in the form of a self-adhesive disk from which a slotted threaded bolt with a central bore extends axially. Specially adapted objects and holders can be fastened non-rotationally on the bolt and secured with a special threaded nut.

A plate which is made of PVC or a similar material and is self-adhesive on the rear is known from CN 203 041 774 U. One or more threaded bolts, onto which threaded nuts can be screwed, extend from the front surface of the plate in the direction of the surface normal.

However, it is a disadvantage of the known solutions that the threaded screws or the threaded nuts can be mounted on the counterpiece bearing a thread only by being screwed on. When the threaded screw or the threaded nut can move in a helical curve only along the thread of the counterpiece, a certain number of turns are needed until the threaded screw or threaded nut bears against the object to be fastened. In addition, tightening torques can result, even at relatively small thread diameters of, for example, 5 mm, that are so great that the adhesive bonding of the holding device can be affected.

The object of the invention is to provide a holding device in which the fastening element for fixing an object hung on the holding body can be mounted particularly simply and easily, and in addition the tightening or loosening torque of the fastening element is limited.

The invention is achieved with a holding device and a holding body according to the independent claims.

According to the invention, it is provided that the holding device for adhesive fastening to a surface comprises a holding body and an associated fastening element, wherein the holding body has a base plate with a preferably flat rear surface and a threaded bolt projecting from the base plate, wherein the fastening element can be attached to the threaded bolt of the holding body. The fastening element has a through opening and is designed so that it is elastic at least in the region of the opening, wherein the opening has an internal diameter which is configured in relation to the external diameter of the threaded bolt in such a way that the fastening element can both be pushed onto the threaded bolt and pulled off it by a linear movement and be screwed onto it and unscrewed from it by a turning movement. A particularly simple fixing of an object hung on the threaded bolt is consequently achieved by the fastening element being capable of being pushed onto the threaded bolt for fixing without expending great force or requiring much time. Rapid mounting of the fastening element is thus possible.

When pushing the fastening element on, a force is thus exerted which is directed at least predominantly in the direction of a normal through the base plate in the direction of the surface such that the holding body or the holding device is pressed against the surface, which preserves the adhesive bonding and even reinforces it by the additional contact pressure. At the same time, the forces that occur when the fastening element is pulled off and which could weaken the adhesive join can be limited in this way by the fastening element which is configured so that it is elastic at least in the region of the opening. Moreover, the torsional stresses which occur when the fastening element is screwed on or unscrewed and likewise weaken the adhesive join can be limited.

It is thus provided for the solution according to the invention that the fastening element is designed so that it is elastic in the region of the opening so that the fastening element can be provided in the region of the opening with a contour which, when screwed on or unscrewed, engages in the thread of the threaded bolt and thus forms a positive connection, whilst the latter, when the fastening element is pushed on and pulled off, is deformed by virtue of its elasticity to such an extent that it slides over the thread of the threaded bolt and consequently permits the pushing-on and pulling-off movement.

Advantageous developments and improvements of the holding device provided in the independent claim are possible as a result of the measures presented in the dependent claims.

According to an advantageous development, it is provided that the fastening element can be deformed by a force in such a way that the fastening element can, in a deformed state of the opening, be pushed onto the threaded bolt and pulled off it and, in an undeformed state of the opening, can be screwed onto or unscrewed from the threaded bolt. In the undeformed state, only low forces can be transmitted so that the screwing forces are limited by the elasticity of the fastening element in the region of the opening. The opening of the fastening element can be enlarged by deformation so that it is easier to push on and/or pull off the fastening element.

According to a preferred embodiment, it is provided that the fastening element is made from an elastomer. Elastomers can be produced simply and cost-effectively in an injection-molding process. Thermoplastic elastomers, in particular polyurethane, which have a good wear resistance, a high UV resistance, and a relatively high tear resistance are particularly preferred here.

The use of an elastomer with a Shore A hardness of between 58 and 94 is advantageous here. The hardness is thus above a Shore A hardness of the human fingertip, as a result of which the material is, on the one hand, sufficiently solid to allow simple handling during mounting and, on the other hand, is sufficiently elastic to obtain the advantages described in the preceding sections.

According to an advantageous development, it is provided that an inner surface, limiting the through opening, of the fastening element has a profile of a helical rib. The helical rib here represents an inwardly projecting profile, as a result of which the engagement region between the fastening element and the threaded bolt is restricted to the region of the helical rib. Both the forces during pushing on and pulling off and the torques during screwing on and unscrewing can be reduced by the reduced engagement regions. It is particularly advantageous here if the profile is designed on a helical curve with the pitch P and an angular range φ of at least 270° and no more than 360° about an axis of the fastening element.

According to an advantageous development, it is provided that the threaded bolt has an external thread with a pitch P less than 1.5 mm, preferably a pitch between 0.25 mm and 1 mm. The thread profile angle α of the threaded bolt here preferably corresponds to the thread profile angle β of the helical rib. The screwing torques for achieving a defined tensioning force can be reduced by a relatively small pitch.

According to a further advantageous development, it is provided that the fastening element can be pulled off with a tensile force F2 of between at least [2n×B] N/cm and [10n×B] N/cm, wherein n is the number of the double-sided self-adhesive strips used and B the width of one of the double-sided self-adhesive strips of a predetermined length L. It is assumed here that the holding body is fixed to a surface by means of standardized adhesive strips with a predetermined length L and a predetermined width B, wherein the length L preferably corresponds to the longitudinal extent of the holding body. It is furthermore assumed that the fingertips gripping the fastening element at opposite outer regions exert a force, oriented perpendicularly to the direction of the tensile force F2, which is sufficient to hold the fastening element when it is pulled off the threaded bolt. This sufficient radial holding force F2 can be, for example, 10 N or greater. The upper threshold value can prevent the self-adhesive strip becoming detached from the surface when the fastening element is pulled off. The lower threshold value ensures that a sufficient force is required to pull off the fastening element such that the latter can absorb axially exerted forces and does not fall off as a result of inadvertent contact.

According to a further advantageous development, it is provided that the double-sided self-adhesive strip has a width B and a length L, wherein the length L is greater than the width B, and an external thread of the threaded bolt has a pitch of 0.01×L. The torques when the fastening element is screwed on or unscrewed can be influenced by the pitch selected. By virtue of a pitch of no more than 0.01×L, these torques can be limited in such a way that no unacceptably high torques occur at the adhesion point which could result in damage to the surface and/or in failure of the adhesive join.

According to a further advantageous embodiment, it is provided that a torque required to screw on or unscrew the fastening element is no more than [100n×B] N, wherein n is the number of double-sided self-adhesive strips and B is the width of one of the double-sided self-adhesive strips. It is assumed here that the fingertips gripping the fastening element at opposite regions exert a force oriented radially with respect to the fastening element in order to hold the fastening element in place when being turned on the threaded bolt. This sufficient radial holding force can be, for example, 10 N or higher.

According to a development of the invention, it is provided that the external thread of the threaded bolt has a thread profile depth which is reduced compared with a standard thread. By virtue of a reduced thread profile depth, the forces when the fastening element is pushed on or pulled off and when the fastening element is screwed on or unscrewed can likewise be reduced.

According to a further advantageous development, it is provided that a support plate of the holding body bears the threaded bolt and can be displaced relatively with respect to the base plate. It is thus also possible for the position of the threaded bolt to be adjusted after the holding body has been fixed. It is particularly advantageous here if the support plate can be displaced relative to the base plate in the direction of the main load when being mounted on a vertical wall, for example vertically, because it is thus possible to adjust the height of an object hung on the holding body. This is particularly advantageous if the object is hung on two or more holding bodies because subsequent adjustment of the height position is thus possible and deviation from the height position of two holding bodies can be corrected subsequently after the holding bodies have been adhesively bonded to the surface.

According to a further advantageous development, it is provided that an outer profile of the fastening element is designed with a sawtoothed, triangular, or double-triangular shape. When a force applied from outside is exerted on a curved wall surface of the fastening element, a deformation results which is similar to this outer profile and thus favors the pushing-on and pulling-off of the fastening element.

The invention is explained below with the aid of preferred embodiments with reference to the attached drawings, in which:

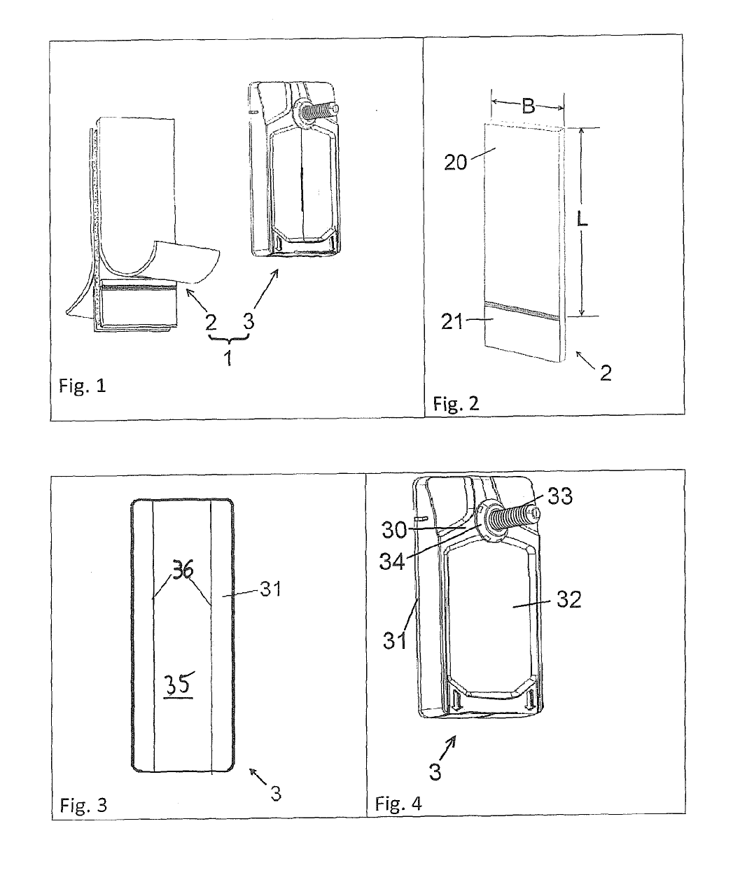

FIG. 1 shows a holding device according to the invention;

FIG. 2 shows a double-sided adhesive strip;

FIG. 3 shows a rear view of a holding body according to the invention of the holding device;

FIG. 4 shows a front view of a holding body of the holding device according to the invention;

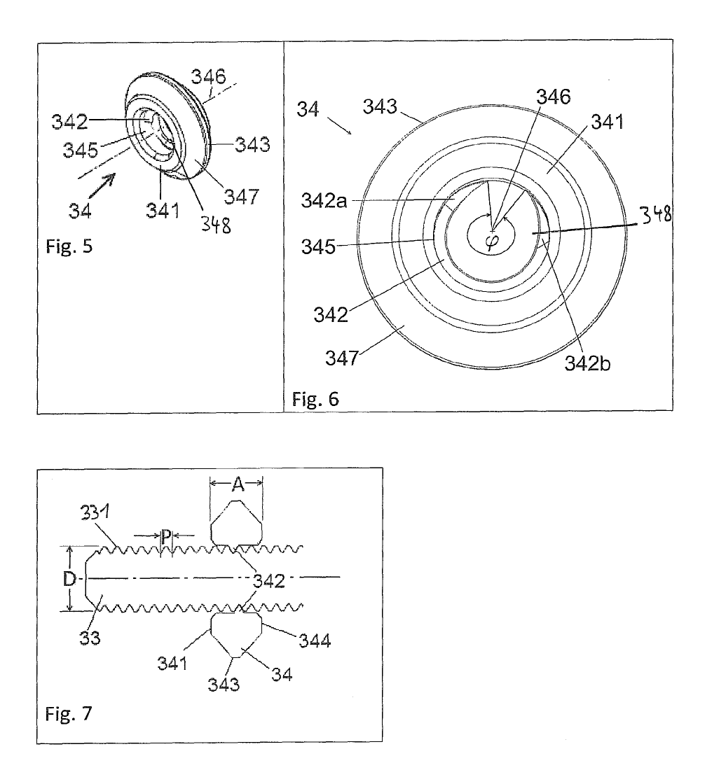

FIG. 5 shows a fastening element of a holding device according to the invention in a perspective view;

FIG. 6 shows the fastening element from FIG. 5 in plan view;

FIG. 7 shows a profile of a threaded bolt of a holding body and of the fastening element in axial section;

FIG. 8 shows a detailed profile of the threaded bolt and of the fastening element;

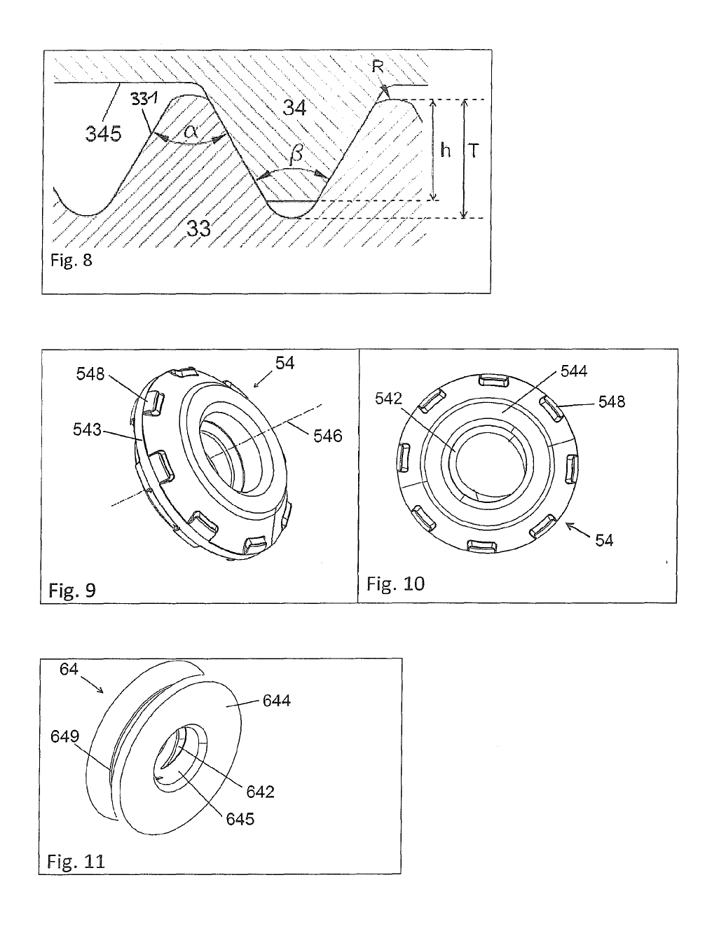

FIG. 9 shows an alternative embodiment of the fastening element in a perspective view;

FIG. 10 shows a plan view of the fastening element from FIG. 9;

FIG. 11 shows a further embodiment of a fastening element;

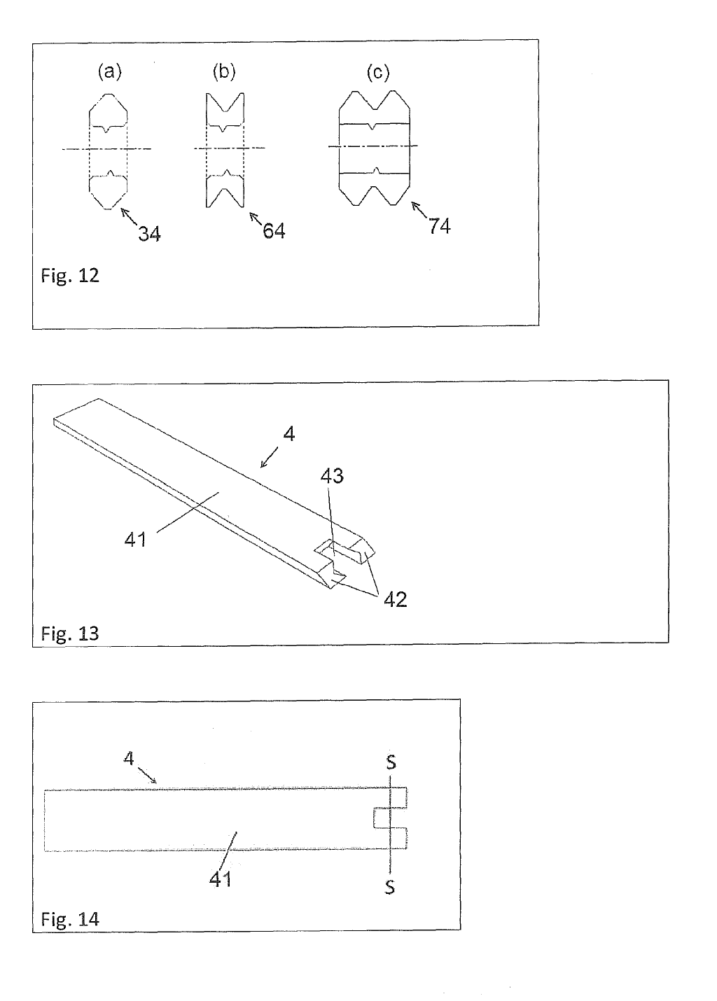

FIG. 12 shows profiles of multiple embodiments of fastening elements;

FIG. 13 shows a tool for mounting and dismounting a fastening element;

FIG. 14 shows a plan view of the tool from FIG. 13;

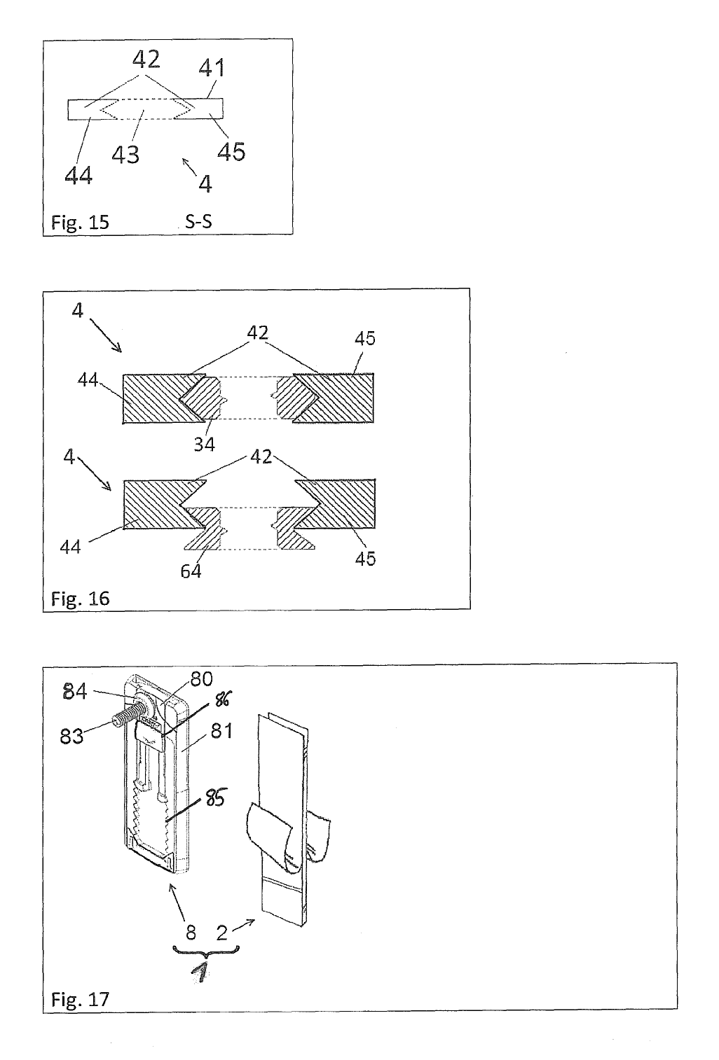

FIG. 15 shows a section through the tool from FIG. 13;

FIG. 16 shows a diagram of the interaction of the tool with a fastening element;

FIG. 17 shows a further embodiment of a holding device according to the invention;

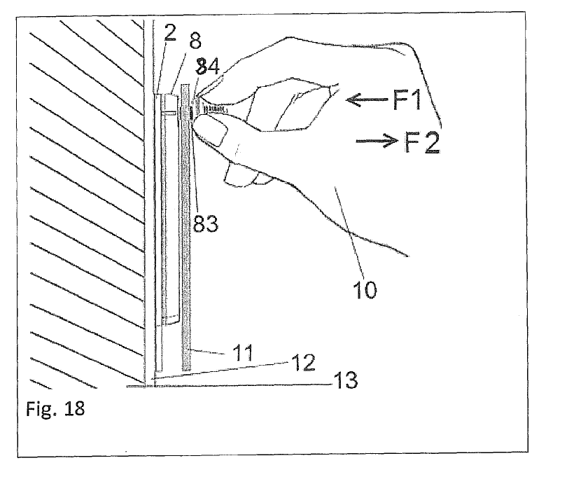

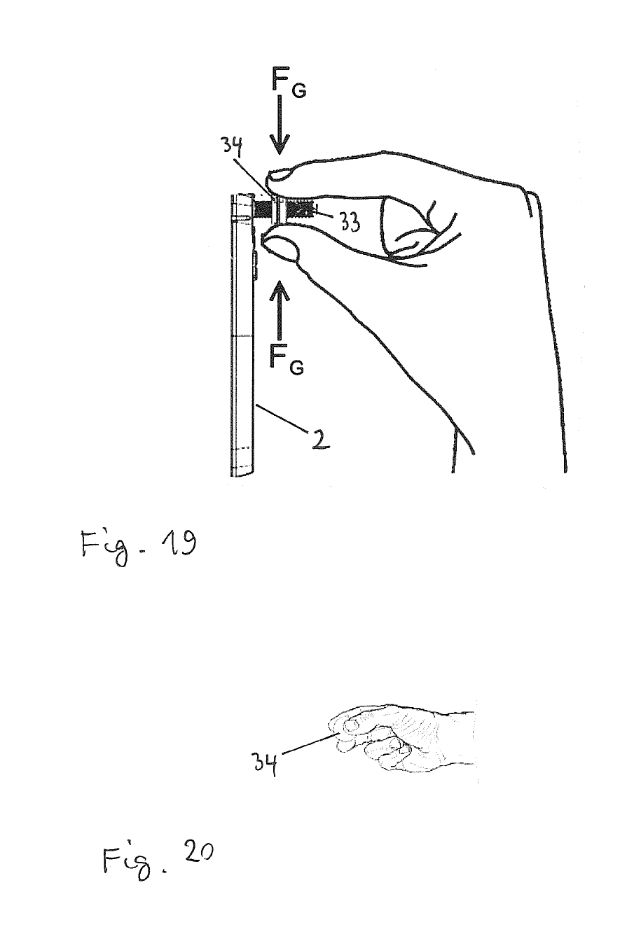

FIG. 18 shows an example of the application of a holding device according to the invention;

FIG. 19 shows a side view to illustrate the gripping forces which act radially;

FIG. 20 shows a schematic view of the three-fingered precision grip using thumb, index finger, and middle finger.

A first exemplary embodiment of a holding device 1 according to the invention is shown in FIG. 1. The holding device 1 comprises a holding body 3, a double-sided self-adhesive strip 2, and a fastening element 34 shown in FIG. 5.

A double-sided self-adhesive strip 2 is shown in FIG. 2. The self-adhesive strip 2 is rectangular with a width B and a length L, the length L being greater than the width B. According to a preferred embodiment, the self-adhesive strip 2 has a maximum width of 24 mm and a maximum length of 80 mm, preferably a width of no more than 21 mm and a length of no more than 61 mm. It has two opposite main surfaces 22, 23 and can be designed so that it can become unbonded by being pulled. Double-sided self-adhesive strips which can become unbonded by being pulled and which, after being stretched and elongated in the direction of a subsurface, can be detached again from the latter are already known from other applications from the prior art. The opposite rectangular tacky main surfaces 22, 23 are here covered in each case with a protective film (not shown in FIG. 2) which is removed before use. An end region of the adhesive strip 2 can be designed so that it is non-adhesive, so that a handle 21, which can be gripped by hand, is provided. For this purpose, portions of plastic film, metal foil, or paper can be on opposite end regions of the tacky main surfaces 22, 23. In addition, the handle 21 can have a special substrate, in particular a foam substrate, in order to make it easier to grip the handle 21.

The tacky main surfaces 22, 23 of generic strips 2 usually have a length L of up to 86 mm and a width of up to 24 mm and are bonded in an adhesive join between a surface and an object fastened by means of the strip 2 such that the non-adhesive handle 21 can still be reached so that it can be stretched and elongated to detach the strip. The handle 21 usually has the same width as the tacky main surfaces 22, 23 and a length of 3 mm to 40 mm.

During the use of the strip 2, the first tacky main surface 22 of the double-sided self-adhesive strip 2 is first pressed firmly on a surface, wherein the long side of the strip 2 is oriented at least largely parallel to the main loading direction, for example the direction of gravity. The opposite second tacky main surface 23 is then connected adhesively to a rear surface 35 of the holding body 3 by the holding body 3 being pressed firmly onto this second tacky main surface 23.

As shown in the rear view of the holding body 3, the holding body 3 comprises a base plate 31 with a flat or level rear surface 35 which serves as an adhesive surface for a double-sided self-adhesive strip 2. The height and width of the base plate 31 are chosen such that they surround the tacky main surfaces 22, 23 of the associated double-sided self-adhesive strip 2. One or more ventilation channels 36 can be provided in the rear surface 35.

The holding body 3 is shown in a front view in FIG. 4. The base plate 31 of the holding body 3 is provided with a support plate 30. A threaded bolt 33, the axis of which is oriented perpendicularly or largely perpendicularly to the rear surface 35 of the base plate 31, extends from the support plate 30. The threaded bolt 33 has a root which lies in the support plate 30, and a free end.

The threaded bolt 33 here has a nominal diameter D and a preferably single-start thread 331 with a pitch P (see FIG. 7). The thread 331 here has a pitch P of no more than 1.5 mm, preferably between 0.25 mm and 1 mm. The choice of the nominal diameter D depends on the objects to be hung. For light household objects, a nominal diameter D of 2 mm to 8 mm is advantageous, and the nominal diameter D is preferably in a range between 3 mm and 5 mm, particularly preferably between 3 mm and 4 mm. The base plate 31 is connected to the support plate 30 and the threaded bolt 33 so that it is designed as a single piece produced as an injection-molded part and hence cannot be detached.

FIG. 5 shows a fastening element 34 of a holding device 1 according to the invention. The fastening element 34 is designed in the manner of a threaded nut. A base body of the fastening element 34 results when two identical frustoconical bodies are theoretically connected to each other coaxially at their disk-like base surfaces in overlapping fashion so that their cover surfaces are spaced apart from each other. A recess with a circular cross-section runs coaxially through both truncated cones. The diameter of the base surface corresponds to the largest external diameter of the fastening element 34. The external diameter measured radially reduces the greater the distance, on an axial coordinate, from the base surface of the truncated cones. The cover surface 341 of the first truncated cone runs parallel to the cover surface of the second truncated cone. The cover surface 341 at the same time forms the axially outer end surfaces 341 of the fastening element 34.

The fastening element 34 can be flattened in the region of the maximum outer circumference 343. The diameter of the central recess corresponds to the nominal diameter of the threaded bolt 33 and can deviate by up to 10% therefrom up or down. The central recess is limited radially by a curved inner surface 345. The profile of a helical rib 342 extends from this inner surface 345 into the axial recess of the fastening element 34. The profile base of the helical rib 342 runs along a helical curve with a pitch P on the inner surface of the fastening element 34 and here describes an angle φ of between 270° and 360° about the axis 346 of the fastening element 34. The helical rib 342 can run continuously or discontinuously and ends after at least one revolution along the inner surface 345. The fastening element 34 thus comprises in particular two thread gaps or thread grooves, which occur between multiple threads, and there are no regions of the helical rib 342 which overlap in a direction parallel to the axis 346. Because of this lack of overlap, it is easier to push on and pull off the fastening element 34 and in particular production after the deformation process is simplified.

The beginning and end of the helical rib 342 are offset axially inward with respect to the outer end surface and advantageously begin and end with a bevel. The fastening element 34 is made from an elastomer, preferably a thermoplastic elastomer.

FIG. 6 shows the fastening element 34 in a view where the viewing direction coincides with the axis 346 of the fastening element 34. The helical rib 342 rises from the inner surface 345, beginning with a bevel 342a, and moves closer to the viewer in a counterclockwise direction. After describing an angle φ which lies within an angular range of between 270° and 360° and in the exemplary embodiment shown is 316° , the helical rib 342 ends again with a bevel 342b. The inner surface 345 adjoins radially outward a hollow cylindrical part of the base body, which is shown in the view as an annular end surface 341. The radially outer region is formed by curved wall surfaces 347. The radially outer end forms the region of the maximum outer circumference 343, which corresponds to approximately twice the nominal diameter D.

FIG. 7 shows, in an axial section, a part of the threaded bolt 33 with a nominal diameter D and a pitch P, and a part of the fastening element 34. That profile of the helical rib 342 which projects inward from the inner surface 345 of the fastening element 34 lies, in this view, in two opposite thread gaps, offset by half a pitch P, of the bolt thread 331. The axial extent A of the cylindrical inner surface 345 is identical to the maximum extent of the fastening element 34 in the axial direction and is advantageously at least three times the pitch P.

The helical rib 342 advantageously lies in the center, between the axially outer end surfaces 341, 344 of the fastening element 34. This means that the distance, measured parallel to the axis 346, between the beginning of the helical rib 342 and the nearest first end surface 341 corresponds to the corresponding distance between the end of the helical rib 342 and the nearest second end surface 344. Alternatively, the projection of the helical rib 342 can lie centrally between the end surfaces 341, 344, on the axis 346.

FIG. 8 shows a thread profile of the threaded bolt 33 and a profile of the helical rib 342 on the fastening element 34. The profiles are based on a metric ISO regular thread, as described in ISO 1502 and DIN 13. The helical rib 342 preferably has a trapezoidal thread with a 60° flank angle. A Whitworth thread is alternatively possible. The thread profile angle α of the bolt 33 preferably corresponds to the thread profile angle β of the helical rib 342 of the fastening element 34, a deviation of up to 20° being possible.

In contrast to the metric ISO regular thread, the thread load-bearing depth h can be reduced by the thread profile height T being reduced on the bolt 33. The thread tips of the bolt thread 331 are rounded with a radius R. A metal threaded nut of corresponding standard and with a suitable nominal diameter D can preferably also be screwed, additionally or instead, onto the bolt thread 331. It is also possible for two or more elastic fastening elements 34 to be screwed on.

FIG. 9 and FIG. 10 show an alternative embodiment of a fastening element 54. The fastening element 54 is made from an elastomer, preferably from a thermoplastic elastomer. Ribs 548, which in each case lie parallel to the axis 546, extend from an outer ring 543 in addition to the above-described design. Starting from the outer ring 543, the ribs 548 extend on both sides and are distributed at uniform angular gaps around the circumference of the fastening element 54. Because the fastening element 54 is also handled without the use of a tool, between the fingertips of a human hand, the ribs 548 can, as structural elements, make the holding element 54 easier to grip. This can be advantageous in the case of surface-smooth elastomers such as, for example, silicone elastomers.

The holding force required for handling using a precision grip is reduced by modifying the grip, as a result of increasing the adhesive friction between the outer surfaces of the fastening element 54 and the fingertips of a human hand. The fastening element 54 is consequently prevented from being pressed too much against the threads of the bolt 33 owing to a strong grip of the hand, as a result of which the torque to be applied by hand when screwing on or unscrewing and the required force when pulling off axially would increase undesirably.

A further embodiment of a fastening element 64 is shown in FIG. 11. The base body of the fastening element 64 is composed of two identical rotationally symmetrical truncated cones. This time, it is the base surfaces and not the cover surfaces of the truncated cones which are connected in a superposed overlapping fashion, and the base surfaces form the end surfaces 641, 644 of the fastening element 64, spaced apart from each other. This means that the external circumference of the fastening element 64 increases up to the end surfaces 641, 644 the farther you move away from the central cover surface, on the axis 646 of the fastening element 64. A central constriction 649 of the fastening element 64 results and the form of the radially outwardly situated profile is similar in axial section to a trapezoidal thread gap which is flanked by two triangles.

FIG. 12a to FIG. 12c show the profiles, in axial section, of different embodiments of fastening element 34, 64, 74. The radially outwardly situated profiles of the fastening element 34, 64, 74 comprise in each case right-angled triangles with hypotenuses situated on the outside. The hypotenuses are at an angle to the axis 346 and form the outwardly situated curved wall surfaces on the fastening element 34, 64, 74. Depending on the appearance of their outer profile, the designs are here referred to as a delta or triangle profile (FIG. 12a), as an M or sawtooth profile (FIG. 12b) and as a double-delta or double-triangle profile (FIG. 12c).

A mounting tool 4, using which the mounting or dismounting of the fastening element 34, 54, 64 can, as required, be assisted is shown in FIG. 13 to FIG. 16. Such a tool 4 is particularly helpful when an object, which is intended to be mounted on the holding body 3, covers the threaded bolt 33 and makes it hard to screw on or push on the fastening element 34, 54, 64, 74. As shown in FIG. 13, the mounting tool 4 has a rod-like base body 41 which simultaneously serves as a handle. The base body 41 has two opposite main surfaces, two side surfaces, and two opposite end surfaces.

On one of the end surfaces 42 of the base body 41, a recess 43 serves to receive the fastening element 34, 54, 64, 74. The recess 43 results theoretically by a hexagon situated in the end surface 42 being pushed into the base body 41 with three pairs of sides, in each case parallel to each other, in the direction of the longitudinal axis of said base body. Two of the six sides of the hexagon are both part of the end surface 42 and part of the main surface of the base body 41. The base body 41 can alternatively be bent at right angles one or more times in the region of the recess in order to reach regions which are hard to access.

The drawings in section in FIG. 14 and FIG. 15 illustrate the situation of the geometry of the recess, forming the socket 43, with respect to the end surface 42 of the base body 41.

FIG. 16 shows, by way of example, the situation of different fastening elements 34, 54, 64, 74 in the socket 43 or the mounting tool 4. With respect to a fastening element 34, 54, 64, the mounting tool 4 engages, like an open-end wrench, radially with a threaded nut. In contrast to a threaded nut, however, axial forces are exerted particularly on the fastening elements 34, 54, 64, 74. The flanking cheeks 44, 45 of the mounting tool 4 here receive the delta or M profile of the respective fastening element 34, 54, 64 positively between them. The respective fastening element 34, 54, 64, 74 can be pushed axially onto the threaded bolt 33 between the flanking cheeks 44, 45 of the mounting tool 4. After reaching the desired position, the mounting tool 4 is removed radially from the respective fastening element 34, 54, 64, 74. By virtue of a slight undersizing of the socket 43 situated between the cheeks, a light clamping of the corresponding fastening element 34, 54, 64, 74 in the socket of the mounting tool 4 can optionally be achieved, with the possibility of a frictional transmission of force.

FIG. 17 shows a further embodiment of a holding device 1 according to the invention. Instead of the holding body 3 shown in FIG. 1, the holding device 1 comprises an alternative holding body 8. The holding body 8 has a base plate 81, a support plate 80, a threaded bolt 83 connected to the support plate 80, and a fastening element 84. The support plate 80 is mounted so that it can be displaced in a vertical guide channel 85 of the base plate 81 and can be secured by a locking element 86. The situation of the threaded bolt 83, and hence of the object to be hung, can thus be adapted even after the base plate has been attached to the surface by means of the double-sided self-adhesive strip 2.

FIG. 18 shows a height-adjustable holding body 8 already fastened on a surface 12 of a wall 13 with the double-sided self-adhesive strip 2. For example, a flat object 11, which can be secured by a fastening element 84 against movement away from the wall 13, hangs on the threaded bolt 83 of the holding body 8. Between the fingertips of a hand 10, the fastening element 34, 84 can be mounted on the threaded bolt 83 by applying a pushing-on force F1 directed perpendicularly to the wall without turning the fastening element 84. No torsional forces are thus transmitted to the double-sided strip 2.

Similarly, the fastening element 84 can be detached by gripping the fastening element 84 between the fingertips of the hand 10 by its curved wall or end surfaces and pulling it off the threaded bolt 83 with a pulling-off force F2 in the direction of the axis of the threaded bolt 83. The pulling-off force is thus limited by the proposed solution and depends on the internal diameter of the thread. In the case of a thread M4, for example, a maximum axial pulling-off force F2 of 5-10 N thus results, i.e. a maximum of (B×200 N)/m. In addition, the pulling-off force F2 depends on the rear adhesive surface, i.e. the rear surface 35 of the holding body 3, 8. Likewise, the fastening element 84 can be taken hold of in a precision grip between the thumb and another finger of the hand 10, in particular between the fleshy inside of an end phalanx of the thumb and the fingertips of the index finger and be screwed onto the threaded bolt 83 by turning in a clockwise direction. Accordingly, the fastening element 84 can be detached by turning in a counterclockwise direction. When the fastening element 84 is pushed onto or pulled off the threaded bolt 83 linearly, the latter is deformed elastically each time the helical rib 342 of the fastening element 84 jumps a thread of the threaded bolt 83. A friction coefficient between the fingertips of the hand and the fastening element 84 is thus defined by the choice of material and the surface of the fastening element 84.

In the case of given production materials, the pushing-on force F1 can, like the pulling-off force F2, be adapted by adapting the thread load-bearing depth of thread bolt 83 and helical rib 342. The forces F1 and F2 are of approximately the same size in the case of symmetrical thread profiles. If a greater exertion of force is required in the pulling-off or pushing-on direction, an asymmetrical profile can be chosen as the profile of the helical rib 342, in particular a profile of a buttress thread. An effect similar to that of a ratchet lock results in the case of a buttress thread.

Alternatively, the required forces F1 and F2 can be reduced by a periodically interrupted helical rib 342 being integrally formed on the inner surface 345 of the fastening element 34, 54, 64, 84, instead of a continuous helical rib 342. In order not to damage sensitive surfaces 12 such as wallpaper when the fastening element 34, 54, 64, 74, 84 is removed, the required pulling-off force F2, which acts, via the tacky main surfaces 22, 23 of the adhesive strip 2, on the surface 12 should not exceed a certain threshold value. Tests have shown that the value of this threshold value at which sensitive wallpaper begins to tear correlates significantly with the width of the adhesive strip 2 used.

The fastening element 34, 54, 64, 74, 84 should resist an axial force in order to hold an object thus secured on the threaded bolt 33, 83. A situation where the holding body 3, 8 is adhesively bonded with just one double-sided self-adhesive strip 2 of width B and length L has proven to be expedient. The length of the adhesive strip 2 thus preferably corresponds to the length of the holding body 3. A range for the pulling-off force F2 of at least (2×B) N/cm and at most (10×B) N/cm thus results for the bonding. Accordingly, when a number n of identical double-sided self-adhesive strips 2 are used to bond the holding body 3, 8 to a surface 12, the range of the pulling-off force F2 is multiplied, wherein multiple adhesive strips 2 are preferably arranged parallel along the rear surface 35 of the holding body 3, 8 and extend lengthwise in each case over the length of the holding body 3, 8.

For the use case where the fastening element 34, 54, 64, 74, 84 is mounted by being screwed on the threaded bolt 33, 83, the fastening element 34, 54, 64, 74, 84 allows a tightening torque up to a fixed threshold value. This threshold value too should be chosen so that it is structurally dependent on the width of the double-sided self-adhesive strip 2 thus used and is no more than (100×B) N. Here too, the value when using multiple identical double-sided self-adhesive strips 2 to bond the holding body 3, 8 to the surface 12 is multiplied. The tightening torque is thus limited by the elasticity of the fastening element 34, 54, 64, 74, 84 in the region of the opening 348, by the helical rib 342, owing to its elasticity, jumping the threads of the external thread 331 of the threaded bolt 83 above a certain surface pressure, and as a result an adjusting movement of the fastening element 34, 54, 64, 74, 84 is no longer possible.

If it becomes hard to access the threaded bolt 33, 83 after an object has been hung on the threaded bolt 33, 83, the mounting tool 4 shown in FIG. 13 to FIG. 16 can be used. To do this, the fastening element 34, 54, 64, 74, 84 is placed into the socket 43 of the mounting tool 4 and brought into a position coaxially with the threaded bolt 33, 83. The mounting tool 4 is then moved parallel to the threaded bolt 33, 83 in the direction of the surface 12 and, after having reached the desired position, removed radially from the fastening element 34, 54, 64, 74, 84. The mounting tool 4 can similarly also be used to remove the fastening element 34, 54, 64, 74, 84.

A plastic material, which can be chosen depending on the different factors and deployment locations, is provided as a production material for the holding body 3, 8 and the threaded bolt 33, 83 connected thereto. Where the support plate 30, 80 is designed as a single piece with the base plate 31, 81, the production material should be compatible with the adhesive composition of the double-sided self-adhesive strip 2 and reliably adhere thereto. Moreover, the production material should have a resistance against the most common environmental influences such as moisture, UV radiation, or ozone and exhaust gas pollution without its material properties deteriorating significantly in due course. Low water absorption is desirable for use in wet rooms as water absorption of the holding body generally weakens the quality of the adhesive join.

A material which fulfills these requirements and which works in harmony with double-sided self-adhesive strips is polystyrene. The disadvantageous tendency in polystyrene to form stress cracks can be reduced by using special qualities such as high-impact polystyrene (HIPS), syndiotactic polystyrene or fiber-reinforced polystyrene varieties. A glass fiber percentage of 15%-35% is advantageous here. Polystyrene is characterized by a low water retention, high rigidity, and the possibility of simple processing as an injection-molded part. Alternatively, styrene acrylonitrile (SAN), acrylonitrile styrene acrylate (ASA), acrylonitrile butadiene styrene (ABS), and fiber-reinforced, in particular glass fiber-reinforced acrylonitrile butadiene styrene are also possible as production materials. Alternatively, carbon fiber-reinforced plastics, in particular carbon fiber-reinforced epoxy resin or carbon fiber-reinforced polyether ether ketone (PEEK) can also be used. Alternatively, the holding body 3, 8 can also be designed from steel, in particular stainless steel, an aluminum alloy, ora titanium alloy.

The fastening element 34, 54, 64, 74, 84 is made from an elastomer, preferably from a thermoplastic elastomer (TPE). Thermoplastic elastomers offer advantages with respect to simple and economic processability in the injection-molding process. The fastening element 34, 54, 64, 74, 84 is particularly preferably designed from a thermoplastic polyurethane (TPU) which can be mixed, filled, or reinforced with other substances. Thermoplastic polyurethane has a high abrasion resistance, a high UV resistance, and a high tear resistance.

Thermoplastic elastomers are available in different grades of hardness. The choice of raw materials in a hardness range with a Shore A hardness between 58 and 94 according to DIN 53505 has been shown to be advantageous for the production material of the fastening element 34, 54, 64, 74, 84. A thermoplastic elastomer is preferably filled with carbon black and has a Shore A hardness of approximately 76. This Shore A hardness lies in a range which exceeds the comparable Shore A hardness of a human fingertip, which can be assumed to lie approximately between 30 and 50 Shore A.

The gripping force to be applied for the fastening element is explained in more detail below, in particular with the aid of FIG. 19 and FIG. 20.

Gripping forces during the screwing processes and during the pulling off of the fastening element:

The fastening element 34 is typically taken hold of at two radially opposite outer regions with a precision grip using two fingers, between the thumb and index finger (see FIG. 19). The force exerted by the opposing fingertips radially on the outer profile of the fastening element 34, immediately before the beginning of a screwing or pulling-off movement, is usually 2×F_{G}=2×5 N=10 N.

Two opposite segments of the outer profile thus sink into the tissue of the fingertips such that the contact surface area between the fingertips and the fastening element 34 increases, relative to the contact surface area which would occur if the fingertips did not deform and the fastening element 34 did not sink into the tissue of the fingertips. The fastening element is dimensioned such that these contact surface areas are, for example, 0.4 cm³, i.e. 0.2 cm³ per fingertip in a two-fingered precision grip. This ensures that the fastening element 34, which is also deformed here, can be taken hold of comfortably and painlessly.

Transmittable torque on the fastening element:

The maximum transmittable torque in the case of an assumed static friction coefficient μ=1 and two lever arms HA, half the external diameter long, with no slipping of the fingertips in a two-fingered grip, and with a radial holding force of 2×5 N can be calculated as, for example, 2× (F_{G}×μ×HA)=2×(5N×1×0.0045 m)=0.0045 Nm.

With regard to the screwing process:

Three situations can be distinguished in the screwing process in a two-fingered thumb and finger grip.
1. Turning of the fastening element 34 about the axis of the threaded bolt 33 results, after gripping the fastening element 34, from turning the wrist. There is then no relative movement between the fingertips of the thumb and the index finger.
2. Turning of the fastening element 34 by rolling it between the fingertips. The fingertips of the thumb and index finger then move relative to each other in opposite directions. The fastening element 34 turns between them about the axis of the threaded bolt 33. In this case, the wrist must not move.
3. Combination of 1 and 2.

Alternatively, the fastening element 34 can also be taken hold of by a user gripping it in three fingers (see FIG. 20).

With regard to the pulling-off or pushing-on:

Unlike the screwing process, the fingertips can additionally interact positively with the fastening element 34 when the fastening element 34 is pulled off or pushed on. Thus, the fastening element 34 can be gripped from behind by fingertips when it is pulled off. It is also possible to take hold of the annular external diameter of the fastening element between the end of a fingertip and the underside of the nail, as indicated for example in FIG. 18.

With no positive locking effects, the pulling-off force must be transmitted to the fastening element 34 by static friction from the fingertips. In the case of a radial holding force of 2×5 N=10 N which is assumed by way of example, and an assumed static friction coefficient of μ=1, a maximum of 10 N tensile (normal) force can act on the adhesive join, as otherwise the fingers of the hand would slip off the fastening element 34. This means that, in the said conditions, a maximum of 10 N is sufficient to be able to move the fastening element 34 axially on the threaded rod.

1. A holding device for adhesive fastening to a surface having a holding body and an associated fastening element, wherein the holding body has a base plate with a rear surface and a threaded bolt protruding above the base plate, wherein the fastening element can be attached to the threaded bolt of the holding body, wherein the fastening element has a through opening and is designed so that it is elastic at least in the region of the opening, wherein the opening has an internal diameter which is configured in relation to the external diameter of the threaded bolt in such a way that the fastening element can both be pushed onto the threaded bolt and pulled off it by a linear movement and be screwed onto it and unscrewed from it by a turning movement.

2. The holding device as claimed in claim 1, wherein the fastening element can be deformed, at least in the region of the opening, by a force in such a way that the fastening element can, in a deformed state, be pushed onto the threaded bolt and pulled off it and, in an undeformed state, can be screwed onto or unscrewed from the threaded bolt.

3. The holding device as claimed in claim 1, wherein the fastening element is made from an elastomer, optionally from a thermoplastic elastomer.

4. The holding device as claimed in claim 3, wherein the elastomer has a Shore A hardness of between 58 and 94.

5. The holding device as claimed in claim 1, wherein an inner surface, limiting the through opening, of the fastening element has a profile of a helical rib.

6. The holding device as claimed in claim 5, wherein the profile is designed on a helical curve with the pitch P and an angular range φ of at least 270° and no more than 360° about an axis of the fastening element.

7. The holding device as claimed in claim 1, wherein the threaded bolt has an external thread with a pitch P less than 1.5 mm.

8. The holding device as claimed in claim 1, wherein the threaded bolt has a nominal diameter D of between 2 mm to 8 mm.

9. The holding device as claimed in claim 1, wherein the external thread of the threaded bolt has a thread profile depth which is reduced compared with a standard thread.

10. The holding device as claimed in claim 1, wherein a support plate of the holding body bears the threaded bolt and can be displaced relatively with respect to the base plate, optionally in the direction of the main load.

11. The holding device as claimed in claim 1, wherein an outer profile of the fastening element is designed with a sawtoothed, triangular or double-triangular shape.

12. The holding device as claimed in claim 1, comprising at least one double-sided self-adhesive strip.

13. The holding device as claimed in claim 12, wherein the fastening element can be pulled off with a tensile force F2 of between at least [2n×B] N/cm and no more than [10n×B] N/cm, wherein n is the number of the double-sided self-adhesive strips used and B the width of one of the double-sided self-adhesive strips.

14. The holding device as claimed in claim 12, wherein the double-sided self-adhesive strip has a width B and a length L, wherein the length L is greater than the width B, and an external thread of the threaded bolt has a pitch of no more than 0.01×L.

15. The holding device as claimed in claim 14, wherein a torque required to screw on or unscrew the fastening element is no more than [100n×B] N, wherein n is the number of double-sided self-adhesive strips and B is the width of one of the double-sided self-adhesive strips.
